(19) United States
(12) Patent Application Publication
(10) Pub. No.: US 2007/0008826 A1
(43) Pub. Date: Jan. 11, 2007

(54) Baby feeding timer

(76) Inventor: Chin-Cheng Hung, Shulin City (TW)

Correspondence Address: EGBERT LAW OFFICES, 412 MAIN STREET, 7TH FLOOR, HOUSTON, TX, 77002, US

(21) Appl. No.: 11/175,233

(22) Filed: Jul. 7, 2005

(51) Int. Cl. G04B 19/00; G04F 10/00

(52) U.S. Cl. 368/107; 368/223

(57) ABSTRACT

The baby feeding timer is a timer that is able to record the feeding amount besides recording the present time, previous time, elapsed time, reminding time, basic buttons and alarming LED indicator light. The baby feeding timer has a feeding amount recorder, and the feeding amount recorder may be displayed by adding a pointer with a track on the scale, or adding a pointer with adjustable knob on the scale, or displayed digitally as the references of next feeding.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a baby feeding timer, and more particularly to a timer that is able to record the feeding amount besides the basic functions of a timer, moreover, the recording is displayed by track, knob or displayed digitally as the reference for the next feeding.

### BACKGROUND OF THE INVENTION

Infants rely on the breast milk, if breast milk is unable to provide or provides insufficient amount, it is supplemented by milk or goat milk. However, one thing that does not change is the feeding time, which is shorter and more often, for instance, it can be once every three hours or once every four hours, so that the infant may be able to receive the nutrient and not get hungry. Also because the infant needs to be fed with milk all the time, therefore, it has messed up the biological clock of the adults, who are used to work during the day and sleep during the night. They become forgetful that they would feed the baby shortly after one feeding or forget to feed the baby for a long time, which is the reason why the industry begins to develop the feeding timer.

Today, there is not a feeding timer, or one that has been developed by the industry; the functions of the conventional timer can only record the present feeding timer, or remind the parents the next feeding time, and there may be present time and elapsed time added upon the most. However, the most import thing, the amount of current feeding, is not recorded, which makes it unclear whether the amount should be added for the next feeding, so that the baby may not be too hungry or too stuffed and cause gas in their stomach.

Thus, to overcome the aforementioned problems of the prior art, it would be an advancement if the art to provide an improved structure that can significantly improve the efficacy.

### BRIEF SUMMARY OF THE INVENTION

The fact of the improved effective of the present invention is described as follows:

By this improved structural design, besides recording, timing and alarming by sound and indicator light, the baby feeding timer even has feeding amount recording function, and by so doing, it can solve and answer the parents' questions on the time and amount of the last feeding, which is more practical, newer and more updated structure.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a front view of a preferred embodiment of the present invention.

FIG. 2 shows a back view of a preferred embodiment of the present invention.

FIG. 3 shows a front view of another preferred embodiment of the present invention.

FIG. 4 shows a front view of another preferred embodiment of the present invention.

### DETAILED DESCRIPTION OF THE INVENTION

The features and the advantages of the present invention will be more readily understood upon a thoughtful deliberation of the following detailed description of a preferred embodiment of the present invention with reference to the accompanying drawings.

The most common two questions before the parents feed the baby are:
1. When was last feeding? Because the baby cannot talk, therefore, whether to feed the baby must be determined by the time of last feeding.
2. How much did the baby drink last time? Because sometimes the baby would drink more or less for some reason, if the baby drink less the last time, then the parents should feed the baby early or make up for the last time.

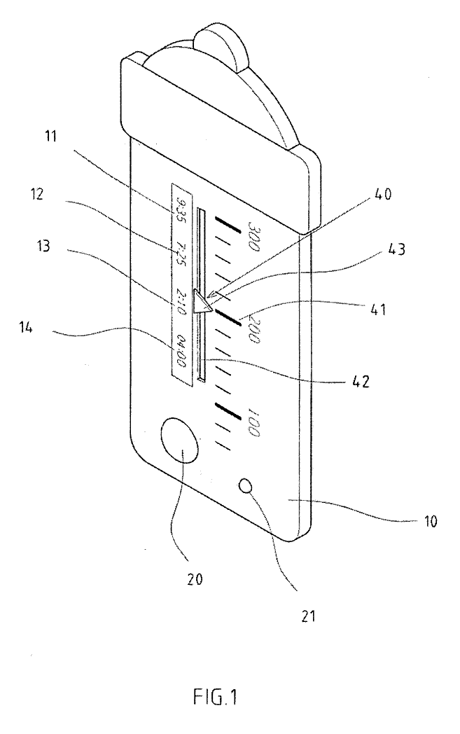

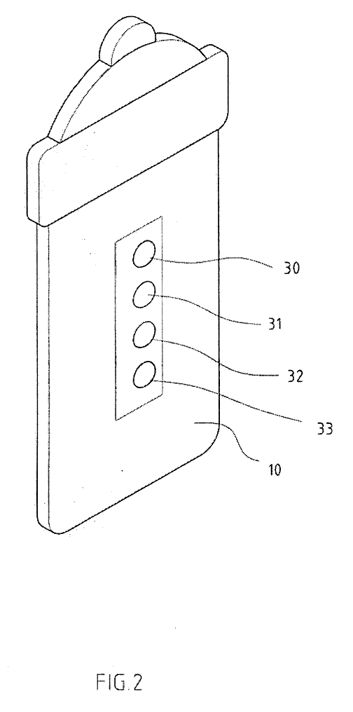

Refer to FIGS. 1 and 2, which show the preferred embodiments of the present invention and back view, among them, the baby feeding time includes the following functions:
1. Current feeding time recording.
2. Last feeding time displaying.
3. Alarm: It can be timed after the current feeding to remind the feeder by the alarming function when it is time.

The baby feeding timer 10 displays the present time 11, previous time 12, elapsed time 13 and reminding time 14. Among them, the present time 11 displays the present time on the user's timer 10, the previous time 12 displays the time of last feeding, the elapsed time 13 displays the time between the present time 11 and previous time 12, and the reminding time 14 displays alarm to remind the parents to feed the baby once every four hours (the time may be set by the users). There is a button 20 on the side of the timer 10, when the button 20 is pushed that means the previous time 12 is reset, and the feeding time restarts; the timer 10 has alarming functions such as alarm sound and LED indicator light 21, and the back of the timer 10 has alarm switch 30, switch button that adjusts the alarm 31, switch button adjusts time (hour) 32, and switch button that adjusts time (minute) 33.

The main function is: a feeding scale 41 on the baby feeding timer 10, a movable pointer 43 is placed inside a track 42, which makes a track feeding amount recorder 40, with this design, the user may line the movable pointer 43 with current feeding scale line after each feeding as the reference to decide whether early feeding or increasing/decreasing amount is needed.

The abovementioned switch button that adjusts the alarm 31 can also be the switch button that adjusts the reminding time 14, which can set thirty minutes as a unit, and reset after six hours.

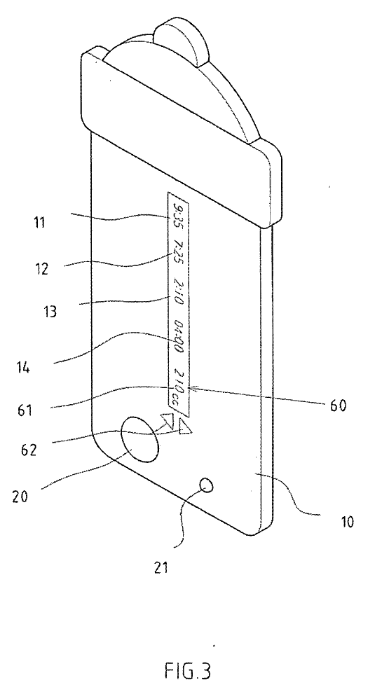

FIG. 3 shows a front view of another preferred embodiment of the present invention. The baby feeding timer 10 also displays present time 11, previous time 12, elapsed time 13 and reminding time 14. There is a button 20 on the side of the timer 10, when the button 20 is pushed that means the previous time 12 is reset, and the feeding time restarts; the timer 10 has alarming functions such as alarm sound and LED indicator light 21, and the back of the timer 10 has alarm switch 30, switch button that adjusts the alarm 31, switch button adjusts time (hour) 32, and switch button that adjusts time (minute) 33.

The main functions are: On the baby feeding timer 10, there is a feeding scale 51 around the knob 52, a knob 52 that has a pointer 53, which makes a knob feeding amount recorder 50, with this design, the user may turn the knob 52 to line the pointer 53 with current feeding scale line after each feeding as the reference to decide whether early feeding or increasing/decreasing amount is needed.

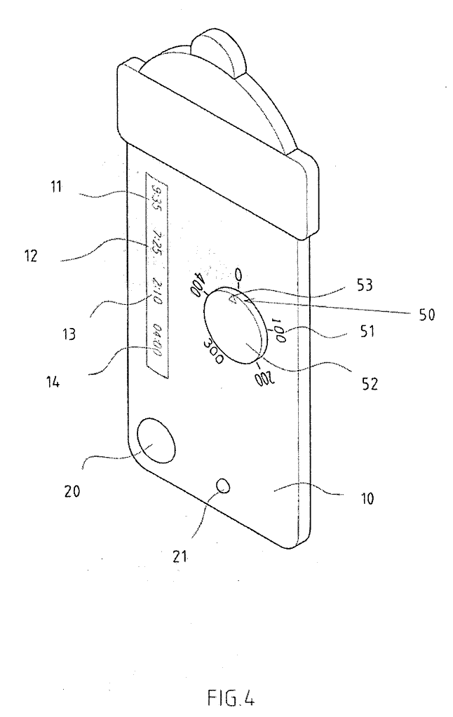

FIG. 4 shows a front view of another preferred embodiment. The baby feeding timer 10 also displays present time 11, previous time 12, elapsed time 13 and reminding time 14. There is a button 20 on the side of the timer 10, when the button 20 is pushed that means the previous time 12 is reset, and the feeding time restarts; the timer 10 has alarming functions such as alarm sound and LED indicator light 21, and the back of the timer 10 has alarm switch, switch button that adjusts the alarm, switch button adjusts time (hour), and switch button that adjusts time (minute).

The main functions are: There is a feeding display 61, a knob 52 that has a pointer 53 on the baby feeding timer 10, and the number on the display 61 shows the amount of the milk in CC, and one the side of the display 61 has a switch button 62 that may be adjusted to move the number up and down, which makes a digital feeding amount recorder 60, with this design, the user may adjust the switch button 62 immediately after each feeding, so that the display 61 displays the amount of current feeding as the reference to decide whether early feeding or increasing/decreasing amount is needed.

1. A baby feeding timer comprising:
several time display components to display all relevant times, and several buttons for adjusting a relevant number or resetting a last feeding time; and
a track feeding amount recorder placed thereon, the feeding amount recorder having a feeding scale and track, and a movable pointer on the track;
wherein a movable pointer with a current feeding scale line after each feeding as the reference is set to decide whether early feeding or increasing/decreasing amount is needed.

2. The structure defined in claim 1, further comprising an alarming device with an alarm sound and LED indicator light.

3. The structure defined in claim 2, further comprising an alarm switch on said alarming device.

4. The structure defined in claim 1, further comprising a switch button adjusting an alarm and a reminding time, being set thirty minutes as a unit, and reset after six hours.

5. A baby feeding timer comprising:
several time display components to display all relevant times, and several switch buttons for adjusting relevant number or resetting a last feeding time; and
a knob is placed thereon and a feeding amount recorder having a feeding scale and track around the knob, and a pointer on the knob;
wherein said knob is lined with the pointer and a current feeding scale line after each feeding as the reference to decide whether early feeding or increasing/decreasing amount is needed.

6. The structure defined in claim 5, further comprising an alarming device with an alarm sound and LED indicator light.

7. The structure defined in claim 6, further comprising an alarm switch on said alarming device.

8. The structure defined in claim 5, further comprising a switch button adjusting an alarm and adjusting a reminding time, being set thirty minutes as a unit, and reset after six hours.

9. A baby feeding timer comprising:
several time display components to display all relevant times, and several switch buttons for adjusting relevant number or resetting a last feeding time; and
a digit display placed thereon, and a feeding amount recorder having a feeding amount display and adjustable switch button;
wherein a switch button is adjustable to display a number to record current feeding after each feeding as a reference to decide whether early feeding or increasing/decreasing amount is needed.

10. The structure defined in claim 9, further comprising an alarming device having an alarm sound and LED indicator light.

11. The structure defined in claim 10, further comprising an alarm switch on said alarming device.

12. The structure defined in claim 9, further comprising a switch button adjusting an alarm and adjusting a reminding time, being set thirty minutes as a unit, and reset after six hours.
